(19) United States
(12) Patent Application Publication
(10) Pub. No.: US 2014/0232772 A1
(43) Pub. Date: Aug. 21, 2014

(54) IMAGE FORMING APPARATUS, IMAGE FORMING METHOD, AND NON-TRANSITORY COMPUTER READABLE MEDIUM

(71) Applicant: FUJI XEROX CO., LTD., Tokyo (JP)

(72) Inventors: Hirotake Sasaki, Kanagawa (JP); Shinji Seto, Kanagawa (JP)

(21) Appl. No.: 13/937,281

(22) Filed: Jul. 9, 2013

(30) Foreign Application Priority Data
Feb. 20, 2013 (JP) 2013-031433

(51) Int. Cl. B41J 2/165

(52) U.S. Cl. CPC B41J 2/16579
USPC 347/14

(57) ABSTRACT

An image forming apparatus includes: a plurality of nozzles that eject liquid droplets; an image forming unit that determines at least some of the plurality of nozzles as nozzles that do not eject liquid droplets, and to form a plurality of images by performing image formation for each of the determined nozzles based on image information predetermined using the remaining nozzles other than the determined nozzles; and an acquisition unit that acquires information representing a defective nozzle which is unusual in ejection of liquid droplets among the plurality of nozzles based on the plurality of images formed by the image forming unit.

### CROSS-REFERENCE TO RELATED APPLICATIONS

This application is based on and claims priority under 35 U.S.C. 119 from Japanese Patent Application No. 2013-031433 filed on Feb. 20, 2013.

### BACKGROUND

### Technical Field

The present invention relates to an image forming apparatus, an image forming method, and a non-transitory computer readable medium.

### SUMMARY

According to an aspect of the invention, an image forming apparatus includes: a plurality of nozzles that eject liquid droplets; an image forming unit that determines at least some of the plurality of nozzles as nozzles that do not eject liquid droplets, and to form a plurality of images by performing image formation for each of the determined nozzles based on image information predetermined using the remaining nozzles other than the determined nozzles; and an acquisition unit that acquires information representing a defective nozzle which is unusual in ejection of liquid droplets among the plurality of nozzles based on the plurality of images formed by the image forming unit.

### BRIEF DESCRIPTION OF THE DRAWINGS

Exemplary embodiment(s) of the present invention will be described in detail based on the following figures, wherein:

FIG. 1 is a side cross-sectional view illustrating a configuration of an image forming apparatus according to an exemplary embodiment;

FIG. 2 is a block diagram illustrating a principal configuration of an electric system of the image forming apparatus according to the exemplary embodiment;

FIG. 3 is a bottom view illustrating a configuration of an ink-jet recording head according to an exemplary embodiment;

FIG. 4 is a flowchart illustrating a processing flow of a defective nozzle specifying program according to a first exemplary embodiment;

FIGS. 5A and 5B are schematic views illustrating examples of a display screen of a UI panel of the image forming apparatus according to the first exemplary embodiment;

FIGS. 6A to 6C are front views illustrating examples of a configuration of a defect detecting chart according to the first exemplary embodiment;

FIGS. 7A to 7D are front views illustrating examples of the types of nozzle defects according an exemplary embodiment;

FIG. 8 shows front views illustrating examples of print results of a defective nozzle specifying pattern according to the first exemplary embodiment and graphs illustrating density read-out results by an optical sensor according to a second exemplary embodiment;

FIG. 9 is a front view illustrating another example of a configuration of a defective nozzle specifying pattern according to the first exemplary embodiment;

FIGS. 10A to 10D are explanatory views for illustrating a correction processing according to an exemplary embodiment;

FIG. 11 is a flowchart illustrating a processing flow of a defective nozzle specifying program according to the second exemplary embodiment;

FIG. 12 is a flowchart illustrating a processing flow of a defective nozzle specifying program according to a third exemplary embodiment;

FIG. 13 is a front view illustrating an exemplary embodiment of a defect detecting chart according to the third exemplary embodiment; and

FIG. 14 shows front views illustrating examples of print results for a defective nozzle specifying pattern according to the third exemplary embodiment and graphs illustrating a density read-out result by an optical sensor.

### DETAILED DESCRIPTION

Hereinafter, the exemplary embodiments of the present invention will be described in detail with reference to drawings.

### First Exemplary Embodiment

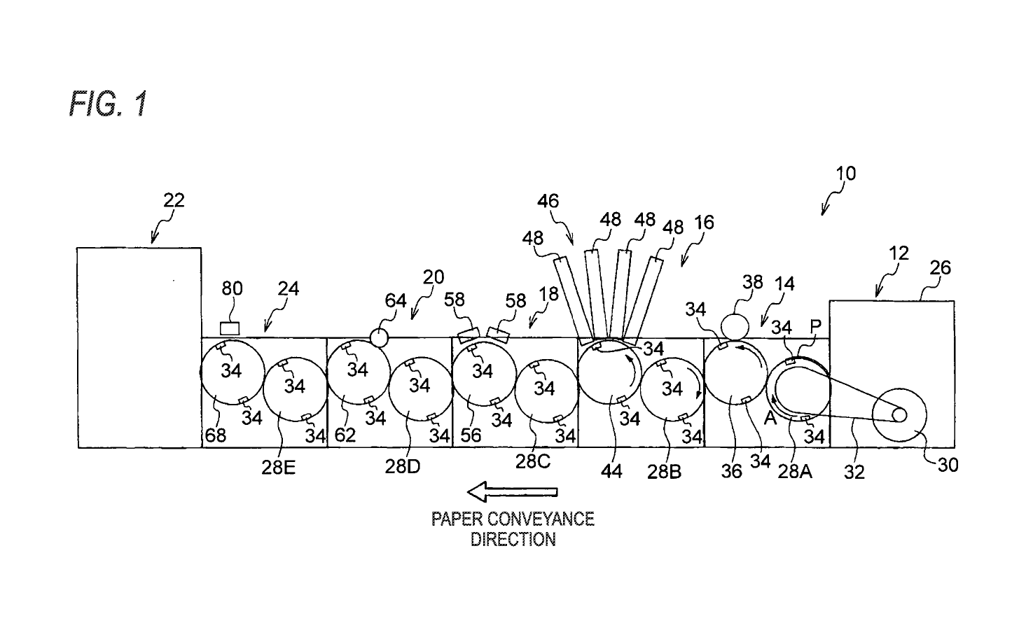

FIG. 1 is a side view illustrating a configuration of an image forming apparatus according to the present exemplary embodiment. As illustrated in the drawing, the image forming apparatus 10 is provided with a paper feed/convey section 12 that feeds and conveys a recording paper P as a recording medium. In the downstream side in the conveyance direction of the paper feed/convey section 12, a processing liquid coating section 14 which coats a processing liquid, which reacts with a coloring material to flocculate a coloring material (pigment) and facilitates separation of the coloring material and a solvent, on a recording surface (front surface) of the recording paper P, an image forming section 16 which forms an image on the recording surface of the recording paper P, a dry section 18 which dries the image formed on the recording surface, an image fixing section 20 which fixes the dried image to the recording paper P, and a discharge/convey section 24 which conveys the image-fixed recording paper P to a discharge section 22 are provided in this order along the conveyance direction of the recording paper P.

The paper feed/convey section 12 is provided with an accommodation section 26 which accommodates the recording paper P. In addition, the accommodation section 26 is provided with a motor 30. Further, the accommodation section 26 is provided with a paper feed apparatus (not illustrated), and the recording paper P is conveyed from the accommodation section 26 to the processing liquid coating section 14 by the paper feed apparatus.

The processing liquid coating section 14 is provided with an intermediate convey drum 28A and a processing liquid coating drum 36. The intermediate convey drum 28A is rotatably disposed in a region interposed between the accommodation section 26 and the processing liquid coating drum 36, and a belt 32 is put on the rotation shaft of the intermediate convey drum 28A and the rotation shaft of the motor 30. Accordingly, the rotation driving force of the motor 30 is transmitted to the intermediate convey drum 28A through the belt 32, thereby rotating the intermediate convey drum 28A in the direction of arrow A.

Also, the intermediate convey drum 28A is provided with retaining members 34 that retain the recording paper P with the leading end of the recording paper P being interposed therebetween. Accordingly, the recording paper P conveyed from the accommodation section 26 to the processing liquid coating section 14 is retained on the outer circumferential surface of the intermediate convey drum 28A through the retaining members 34, and conveyed to the processing liquid coating drum 36 by the rotation of the intermediate convey drum 28A.

Also, a plurality of intermediate convey drums 28B to 28E, a processing liquid coating drum 36, an image forming drum 44, an ink dry drum 56, an image fixing drum 62, and a discharge/convey drum 68 are also provided with the retaining members 34, like the intermediate convey drum 28A. In addition, by the retaining members 34, the transmission/reception of the recording paper P from/to an upstream side drum/a downstream side drum is performed.

The rotation shaft of the processing liquid coating drum 36 is connected to the rotation shaft of the intermediate convey drum 28A by a gear (not illustrated) and rotated by receiving the rotation force of the intermediate convey drum 28A.

The recording paper P conveyed by the intermediate convey drum 28A is conveyed to the processing liquid coating drum 36 through the retaining members 34 of the processing liquid coating drum 36 and conveyed in a state in which it is retained on the outer circumferential surface of the processing liquid coating drum 36.

On the top side of the processing liquid coating drum 36, a processing liquid coating roller 38 is disposed in a state where it is in contact with the outer circumferential surface of the processing liquid coating drum 36 and the processing liquid is coated on the recording surface of the recording paper P on the outer circumferential surface of the processing liquid coating drum 36 by the processing liquid coating roller 38.

The recording paper P coated with the processing liquid by the processing liquid coating section 14 is conveyed to the image forming section 16 by the rotation of the processing liquid coating drum 36.

The image forming section 16 is provided with the intermediate convey drum 28B and the image forming drum 44. The rotation shaft 28B of the intermediate convey drum 28B is connected to the rotation shaft of the processing liquid coating drum 36 through a gear (not illustrated), and rotated by receiving the rotation force of the processing liquid coating drum 36.

The recording paper P conveyed by the processing liquid coating drum 36 is conveyed to the intermediate convey drum 28B through the retaining member 34 of the intermediate convey drum 28B of the image forming section 16 and conveyed in the state it is retained on the outer circumferential surface of the intermediate convey drum 28B.

The rotation shaft of the image forming drum 44 is connected to the rotation shaft of the intermediate convey drum 28B through a gear (not illustrated) and rotated by receiving the rotation force of the intermediate convey drum 28B.

The recording paper P conveyed by the intermediate convey drum 28B is conveyed to the image forming drum 44 through the retaining member 34 of the image forming drum 44 and conveyed in the state it is retained on the outer circumferential surface of the image forming drum 44.

On the top side of the image forming drum 44, a head unit 46 is disposed to be close to the outer circumferential surface of the image forming drum 44. The head unit 46 includes four ink-jet recording heads 48 which correspond to four colors of yellow (Y), magenta (M), cyan (C), and black (K), respectively. These ink jet recording heads 48 are arranged along the circumferential direction of the image forming drum 44 and eject ink droplets from nozzles 48a to overlap with the processing liquid layer formed on the recording surface of the recording paper P in the processing liquid coating section 14 synchronously with a clock signal of a CPU 100 to be described later, thereby forming an image.

Also, although there is also a case a processing liquid is ejected from the nozzles of the ink-jet recording heads according to the present exemplary embodiment, in the present exemplary embodiment, a case where ink droplets are ejected will be exemplified and described.

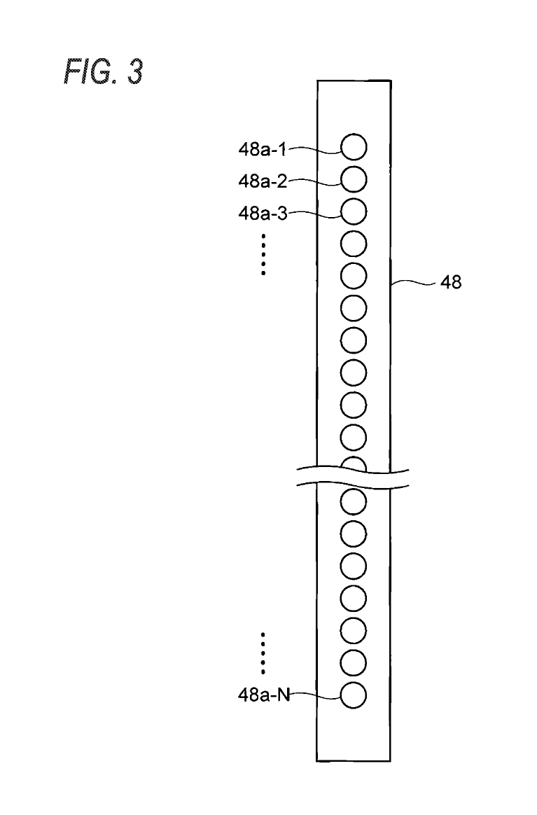

FIG. 3 illustrates an arrangement of the nozzles 48a in each ink jet recording head 48 in the present exemplary embodiment.

Although the number and arrangement of the nozzles 48a of each ink jet recording head 48 are not particularly limited, a configuration, in which N nozzles 48a-1, . . . , 48a-N are arranged in a row and the ink jet recording head 48a is formed as an elongated head to be suitable for the width length of the recording paper P, is employed in the present exemplary embodiment. Accordingly, the ink-jet recording head 48 according to the present exemplary embodiment is a paper width printing type (so-called Full Width Array (FWA)) head in which printing is performed by one pass on the recording paper P which is conveyed continuously. Of course, the ink jet recording head 48 according to the present exemplary embodiment may also be applied to an image forming apparatus that conducts an image printing by so-called multi-passes in which the ink-jet recording head 48 is caused to pass multiple times within the paper width.

Also, the nozzles 48a according to the present exemplary embodiment are assigned numbers of 1 to N to correspond to N nozzles 48a-1, 48a-N, respectively, and these numbers will be referred to as “nozzle numbers”.

Here, the arrangement of the nozzles 48a in the ink-jet recording head 48 are not limited to the above-described arrangement and the nozzles 48a may be arranged in multiple rows or the nozzles 48a in the multiple rows may be alternately arranged in a zigzag type in a two-dimensional arrangement. Further, the ink jet recording head 48 is not limited to that configured by a single body and may be configured by dividing it into plural ink-jet recording heads. In addition, the plurality of ink-jet recording heads 48 may be arranged in a zigzag type.

The recording paper P, which is formed with an image on the recording surface by the image forming section 16, is conveyed to the dry section 18 by the rotation of the image forming drum 44.

The dry section 18 includes an intermediate convey drum 28C and an ink dry drum 56. The rotation shaft of the intermediate convey drum 28C is connected to the rotation shaft of the image forming drum 44 through a gear (not illustrated) and rotated by receiving the rotation force of the image forming drum 44.

The recording paper P conveyed by the image forming drum 44 is conveyed to the intermediate convey drum 28C through the retaining members 34 of the intermediate convey drum 28C and conveyed in the state where it is retained on the outer circumferential surface of the intermediate convey drum 28C.

The rotation shaft of the ink dry drum 56 is connected to the rotation shaft of the intermediate convey drum 28C through a gear (not illustrated) and rotated by receiving the rotation force of the intermediate convey drum 28C.

The recording paper P conveyed by the intermediate convey drum 28C is conveyed to the ink dry drum 56 through the retaining members 34 of the ink dry drum 56 and conveyed in the state it is retained on the outer circumferential surface of the ink dry drum 56.

On the top side of the ink dry drum 56, fan heaters 58 are disposed adjacent to the outer circumferential surface of the ink dry drums 56. By the hot air from the fan heaters 58, surplus solvent in the image formed on the recording paper P is removed. After the image on the recording surface is dried by the dry section 18, the recording paper P is conveyed to the image fixing section 20 by the rotation of the ink dry drum 56.

The image fixing section 20 is provided with an intermediate convey drum 28D and an image fixing drum 62. The rotation shaft of the intermediate convey drum 28D is connected to the rotation shaft of the ink dry drum 56 through a gear (not illustrated) and rotated by receiving the rotation force of the ink dry drum 56.

The recording paper P conveyed by the ink dry drum 56 is conveyed to the intermediate convey drum 28D through the retaining members 34 of the intermediate convey drum 28D and conveyed in the state it is retained on the outer circumferential surface of the intermediate convey drum 28D.

The rotation shaft of the image fixing drum 62 is connected to the rotation shaft of the intermediate convey drum 28D through a gear (not illustrated) and rotated by receiving the rotation force of the intermediate convey drum 28D.

The recording paper P conveyed by the intermediate convey drum 28D is conveyed to the image fixing drum 62 through the retaining members 34 of the image fixing drum 62 and conveyed in the state in which it is retained on the outer circumferential surface of the image fixing drum 62.

On the top side of the image fixing drum 62, a fixing roller 64 having a heater therein is disposed in a state in which the compressive contact or separation of the fixing roller 64 in relation to the outer circumferential surface of the image fixing drum 62 may be selected. The recording paper P retained on the outer circumferential surface of the image fixing drum 62 is sandwiched between the outer circumferential surface of the image fixing drum 62 and the outer circumferential surface of the fixing roller 64 and heated by the heater in the state where it is in compressive contact with the outer circumferential surface of the fixing roller 64. Thus, the coloring material of the image formed on the recording surface of the recording paper P is fused to the recording paper P and the image of the recording paper P is fixed. The recording paper P, on which the image is fixed by the image fixing section 20, is conveyed to the discharge/convey section 24 by the rotation of the image fixing drum 62.

The discharge/convey section 24 is provided with an intermediate convey drum 28E and a discharge/convey drum 68. The rotation shaft of the intermediate convey drum 28E is connected to the rotation shaft of the image fixing drum 62 through a gear (not illustrated) and rotated by receiving the rotation force of the image fixing drum 62.

The recording paper P conveyed by the image fixing drum 62 is conveyed to the intermediate convey drum 28E through the retaining members 34 of the intermediate convey drum 28E and is conveyed in the state in which it is retained on the outer circumferential surface of the intermediate convey drum 28E.

The rotation shaft of the discharge/convey drum 68 is connected to the rotation shaft of the intermediate convey drum 28E through a gear (not illustrated) and rotated by receiving the rotation force of the intermediate convey drum 28E.

The recording paper P conveyed by the intermediate convey drum 28E is conveyed to the discharge/convey drum 68 through the retaining members 34 of the discharge/convey drum 68 and conveyed to the discharge section 22 in the state in which it is retained on the outer circumferential surface of the discharge/convey drum 68.

In addition, the image forming apparatus 10 according to the present exemplary embodiment is provided with an optical sensor 80 on the top side of the discharge/convey drum 68 as a read-out means for reading out various patterns or the like to be described later. The optical sensor 80 is disposed to read out the image printed on the recording paper P while the recording paper P is being conveyed to the discharge section 22 in the state in which it is retained on the outer circumferential surface of the discharge/convey drum 68.

The optical sensor 80 includes a light emitting unit and a light receiving unit which are not illustrated, in which the light emitted from the light emitting unit is reflected by the recording paper P and the light receiving unit detect the reflected light so that a reflection optical density (so-called OD (Optical Density) value (hereinafter, merely referred to as “density”)) of the print region of the recording paper P is measured. In addition, as for the optical sensor 80, a transmissive optical sensor may be used without being limited to a reflective optical sensor.

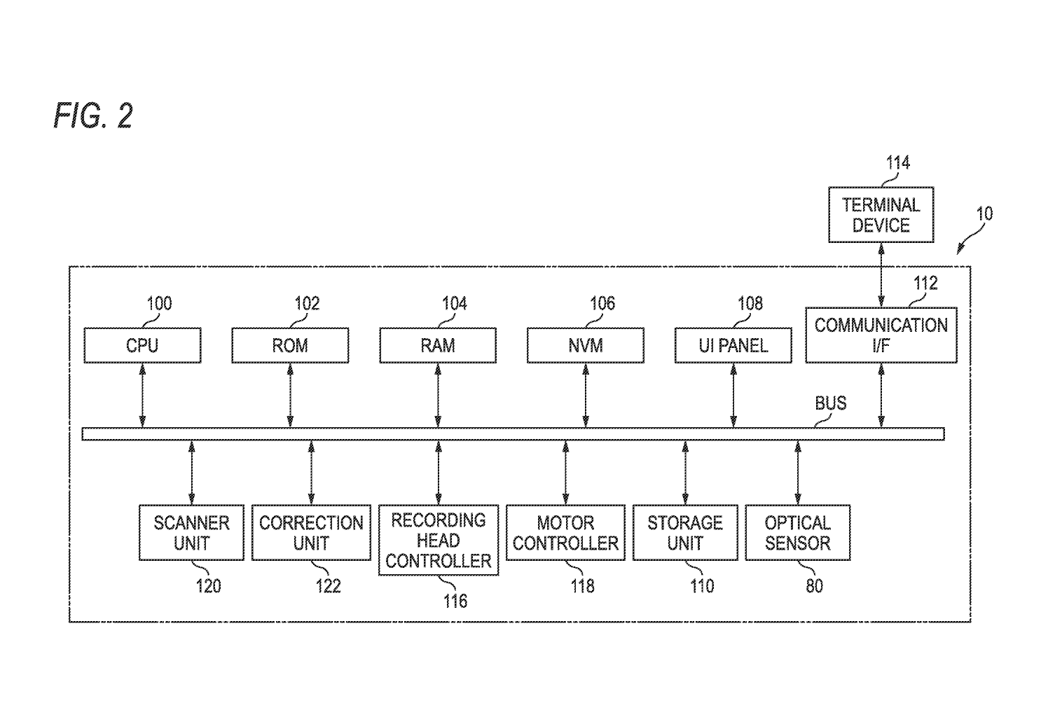

Next, a configuration of an electrical system of the image forming apparatus 10 according to the present exemplary embodiment will be described with reference to FIG. 2.

As illustrated in the drawing, the image forming apparatus 10 includes a CPU (Central Processing Unit) 100, a ROM (Read Only Memory) 102, a RAM (Random Access Memory) 104, an NVM (Non-Volatile Memory) 106, a UI (User Interface) panel 108, and a communication interface 112.

The CPU 100 takes a charge of the entire operation of the image forming apparatus 10. The ROM 102 is a storage medium in which a program for controlling the operation of the image forming apparatus 10, a defective nozzle specifying program to be described later, various parameters or the like are stored in advance. The RAM 104 is a storage medium used as a work area or the like at the time of executing various programs. The NVM 106 is a non-volatile storage medium which stores various information items to be maintained even if the power switch of the apparatus is turned OFF.

The UI panel 108 may be configured by, for example, a touch panel display in which a transmissive touch panel overlaps on the display and various information items are displayed on the display surface of the display. In addition, when the user touches the touch panel, a desired information item or an instruction, for example, the activation of a defective nozzle specifying program to be described or the like is input.

The communication interface 112 is connected to a terminal device 114 such as a personal computer to receive various information items (e.g., image information representing an image formed on a recording paper P) and to transmit various information items (e.g., information representing an operation condition of the image forming apparatus 10) to the terminal device 114.

The CPU 100, the ROM 102, the RAM 104, the NVM 106, the UI panel 108, and the communication interface 112 are interconnected through a bus such as a system bus. Accordingly, the CPU 100 conducts each of access to the ROM 102, the RAM 104 and the NVM 106, displaying of various information items to the UI panel 108, grasp of contents of the user's various operation instructions for the UI panel 108, reception of various information items from the terminal device 114 through the communication interface 112, and transmission of various information items to the terminal device 114 through the communication interface 112.

Further, the image forming apparatus 10 includes a recording head controller 116 and a motor controller 118.

The recording head controller 116 controls the operation of the ink-jet recording head 48 according to an instruction of the CPU 100. The motor controller 118 controls the operation of the motor 30.

The recording head controller 116 and the motor controller 118 are connected to the bus. Accordingly, the CPU 100 controls the operations of the recording head controller 116 and the motor controller 118.

The image forming apparatus 10 of the present exemplary embodiment further includes a storage unit 110 in which a mask file or the like is stored, a scanner unit 120 which reads out a manuscript, and a correction unit 122 which performs a correction processing of a defective printing caused by a defective nozzle on the recording paper P. The storage unit 110, the scanner unit 120 and the correction unit 122 are also connected to the bus and controlled by the CPU 100.

In addition, the above described optical sensor 80 is also connected to the bus and the CPU 100 may grasp a detection value by the optical sensor 80.

Here, as the demand for improving image quality increases, the number of nozzles 48a provided in the ink-jet recording heads 48 is rapidly increased. For example, when print resolution is 1,200 dpi (dots per inch), about 10,000 nozzles 48a are arranged in an A4 size paper width (21 cm).

In each of the ink-jet recording heads 48 provided with the nozzles 48a by the number of such a scale, it is difficult to configure and maintain all the nozzles 48a to enable normal ejection and stochastically, there may be a case in which each ink-jet recording head 48 includes a certain number of defective nozzles (unusual nozzles of which ejection of ink droplets is unusual). For example, defective aspects of the nozzles may include a defect of non-ejection which causes ink droplets not to be ejected, a defect of thin line which causes the ejection amount of ink droplets to decrease, and a defect of deviation of landing position which causes curved flight of ink droplets. If an image is printed on the recording paper P when such defective aspects of nozzles are produced, uneven density may occur in the image. Sometimes, the uneven density may be visually recognized as a stripe.

As a method of detecting a defective nozzle, a method may be referred to in which a test chart for detecting a defective nozzle is printed with a predetermined print density so that a stripe is practically produced, and then determination is made based on the result. It is a method of specifying, for example, a nozzle number of a defective nozzle from the image information obtained by reading out the printed test chart using an optical sensor.

In addition, the print density is an occupying ratio of a printed region in a recording paper P and may also be referred as, for example, a duty or a coverage rate. The print density in the present exemplary embodiment is defined for each color of yellow (Y), magenta (M), cyan (C), and black (K) and also including a monochrome printing.

When a defective nozzle is detected in each ink-jet recording head 48, the ejection of ink droplets is typically stopped for the defective nozzle based on a control by the CPU 100 (hereinbelow, stopping the ejection of ink droplets may be referred to as “masking”). Only with the masking, ink droplets are not ejected always at the position corresponding to the stopped defective nozzle, thereby producing a white stripe in printing on a recording paper P. Thus, there is a case in which ink droplets are ejected to fill the white stripe using a nozzle in the vicinity of the defective nozzle. Hereinafter, making the white stripe invisible in this manner will be referred to as “correction.” The details of correction will be described later.

In general, unusual printing caused by a defective nozzle may be remedied as described above. However, in a recent ink-jet recording head 48 in which the number of nozzles 48a per one line is very large, it is difficult to specify a defective nozzle systematically and efficiently.

In addition, some of the stripes produced by defective nozzles 48a are remarkable at a high print density over a certain high print density, for example, at a print density of 80% to 100%. This is because a number of nozzles are simultaneously driven at the high print density. In addition, when the print density is changed, the stripe-produced position on the recording paper P may be changed occasionally. In the case of such a stripe, it is difficult to specify a defective nozzle in a defective nozzle detecting pattern formed with a single print density as in the past.

Considering the above background, in the image forming apparatus 10 according to the present exemplary embodiment, a defective nozzle is specified by printing a defect detecting chart while sequentially stopping the ejection of ink droplets from a predetermined number (in the present exemplary embodiment, 1) nozzles 48a (hereinbelow, stopping the ejection of ink droplets may also be referred to as “non-operating”).

In that event, since it takes time if the ink-jet recording heads 48 are sequentially non-operated from an end, the non-operating range may be narrow in advance (hereinbelow, the narrowed range will be referred to as a “search range”). Also, the defect detecting chart may be configured such that a nozzle defect occurring with various print densities may be detected.

Thus, in the image forming apparatus 10 according to the present exemplary embodiment, a defective nozzle occurring with various print densities may be efficiently specified while suppressing a possibility of failing to specify the defective nozzle.

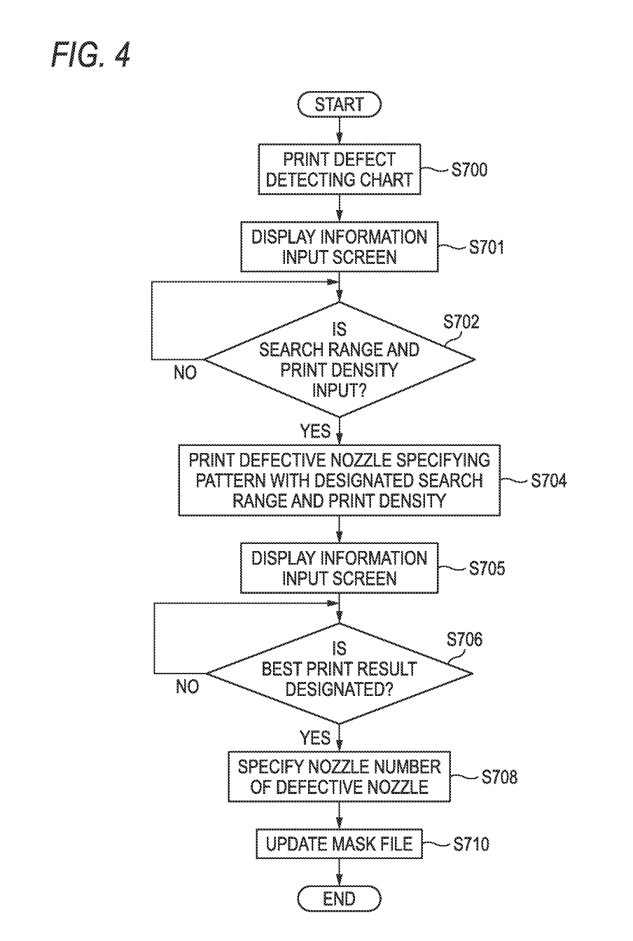

Next, with reference to FIG. 4, the actions of the image forming apparatus 10 according to the present exemplary embodiment will be described. FIG. 4 is a flowchart illustrating a processing flow of a defective nozzle specifying program executed by the CPU 100. The program is stored in a predetermined region in the ROM 102.

Here, in executing the above-described processing, the program may be applied in a type of being provided in a state it is stored in a computer-readable storage medium or in a type of being delivered by a wired or wireless communication means without being limited to the type of being installed in the ROM 102 in advance.

In addition, the processing of the defective nozzle specifying program according the present exemplary embodiment is implemented by a software configuration using a computer by executing the program. However, it is not limited to the implementation using the software configuration, and for example, the processing may be implemented by a hardware configuration employing an ASIC (Application Specific Integrated Circuit) or a combination of the hardware configuration and the software configuration.

Here, the timing for executing the present defective nozzle specifying program by the user may be, for example, [1] when the user confirms a print disorder such as a stripe when a manuscript or the like is printed, or [2] when the user preemptively executes the program, for example, prior to printing an important printed matter.

In order to avoid entangling, here, it is assumed that an execution instruction of a defective nozzle specifying processing has been already made by the user through the UI panel 108 or the like, and in addition, as to a defective nozzle masked in the past, defective nozzle specifying information for specifying the defective nozzle is stored in the storage unit 110 or the like as a mask file (not illustrated). Although there is not special restriction as for the defective nozzle specifying information, the present exemplary embodiment applies nozzle numbers.

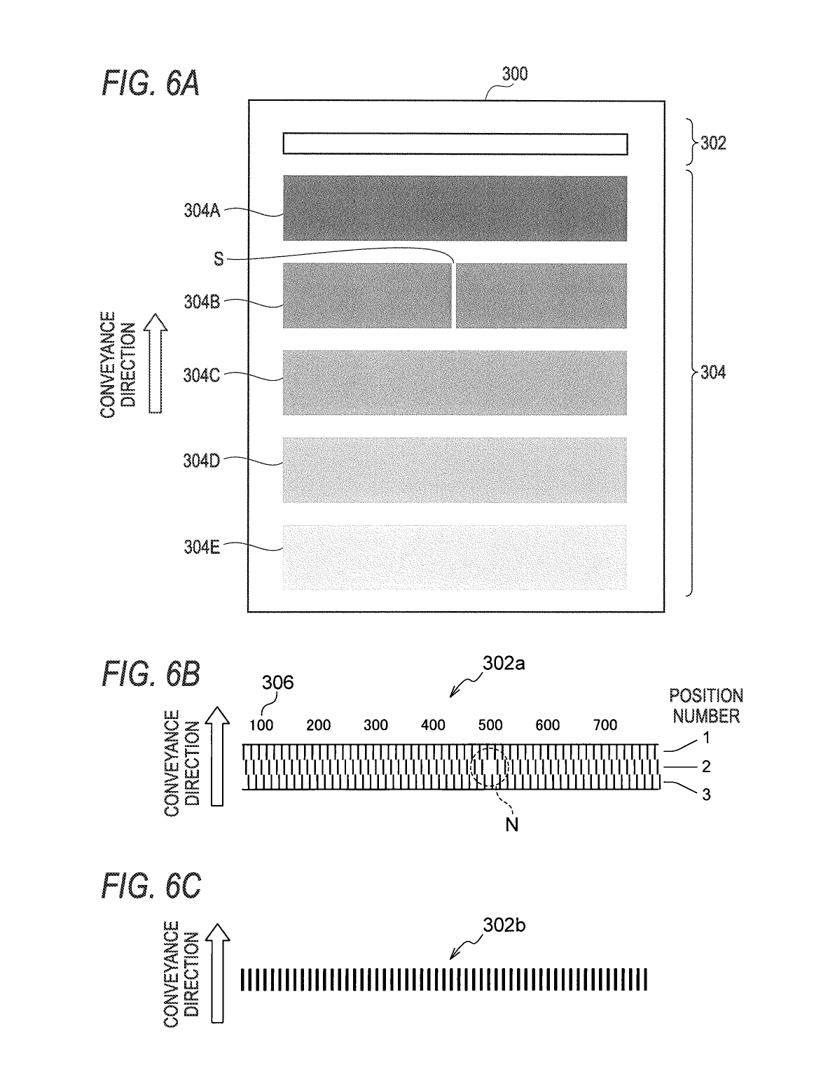

In FIG. 4, in step S700, a defect detecting chart (see FIGS. 6A to 6C) for detecting a defective nozzle is printed. In the present exemplary embodiment, the defect detecting chart is printed while performing a correction processing for the defective nozzles which have been determined until now based on mask files accumulated up to now. Details of the correction processing will be described later.

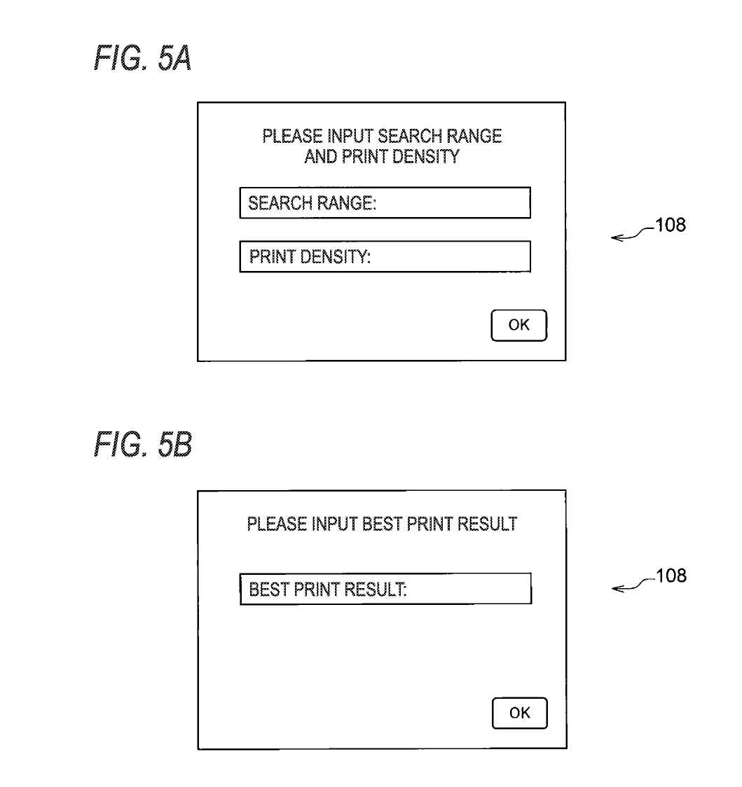

In the next step S701, information input screen for inputting a search range and a print density is displayed on the UI panel 108. An example of the display screen of the UI panel 108 at that time is illustrated in FIG. 5A in which a message, “Please input search range and print density” is displayed together with an input box.

The user specifies a print density where a print disorder occurs simultaneously with specifying the search range with reference to the defect detecting chart printed in step S700 and input the information from the UI panel 108 or the like. Accordingly, in the next step S702, as the input standby of the search range and the print density is performed, standby is made until they are input by the user.

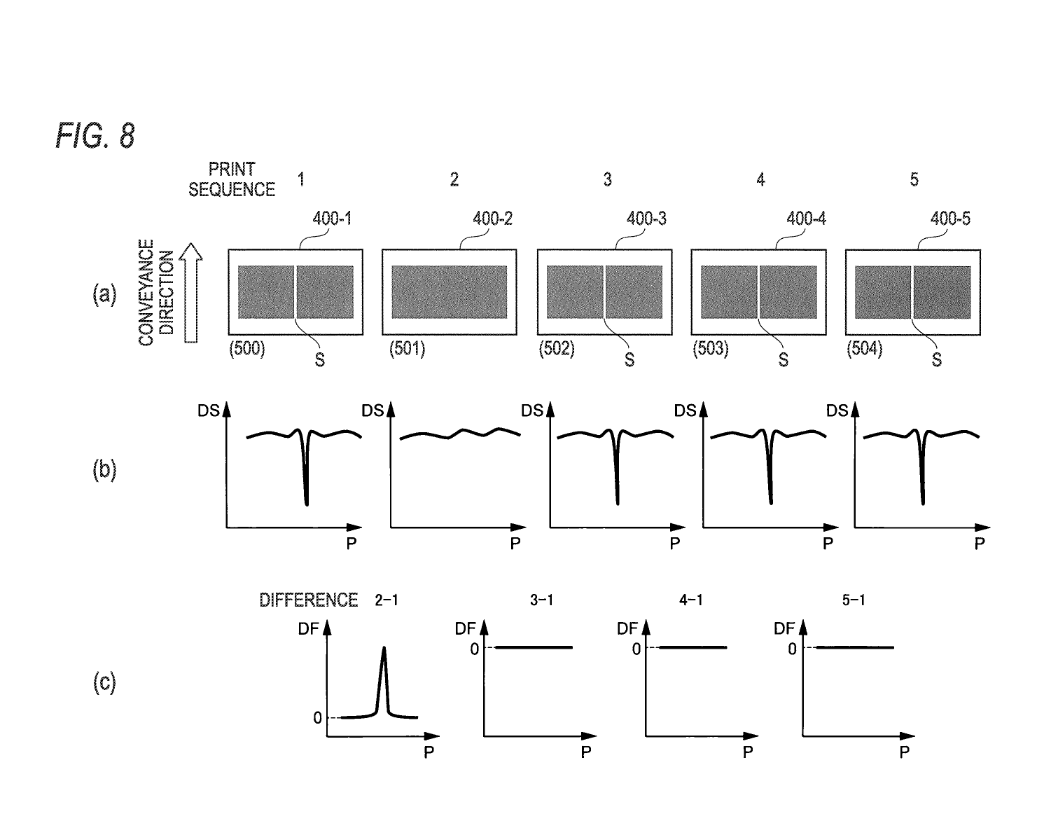

When the search range and the print density are input by the user, in the next step S704, the nozzles are non-operated one by one in the search range based on the search range and the print density designated by the input and the defective nozzle specifying pattern (see FIG. 8) is printed to correspond to the non-operated nozzles. In the present exemplary embodiment, the defective nozzle specifying pattern is printed while performing correction for the defective nozzles determined up to now based on the mask files.

In the next step S705, an information input screen for inputting the most favorable print result is displayed on the UI panel 108. FIG. 5B illustrates an example of the display screen of the UI panel 108 where a message, “Please the best print input,” is displayed together with the input box of the best input result.

According to the following processing, the user visually confirms and compares a plurality of printed defective nozzle specifying patterns, designates a defective nozzle specifying pattern representing a print result considered as the best, and inputs the defective nozzle specifying pattern. Thus, in the next step S706, standby is made until the designation and input of the best print result is performed by the user. The “best print result” refers to the print result that the user has visually confirmed and determined that a stripe is most hardly visible. In addition, in the present exemplary embodiment, the best print result is designated by a number assigned to each defective nozzle specifying pattern (in the exemplary embodiment, the nozzle number of a nozzle non-operated in the defective nozzle specifying pattern).

When the best print result is input in step S706, in the next step S708, a nozzle number of a defective nozzle is specified based on the input best print result.

Next, in step S710, the specified nozzle number of the defective nozzle is added to the mask files stored in the storage unit 110 to update the mask files and the defective nozzle specifying program is ended.

In addition, when updating the mask files, beyond merely adding a nozzle number of a defective nozzle, if a nozzle which has been considered defective is not determined as a defective nozzle as a result of executing the defective nozzle specifying program according to the present exemplary embodiment, the nozzle number of the nozzle may be deleted from the mask files.

The defective nozzle specifying program according to the present exemplary embodiment is a program executed prior to practical printing. After the present program is executed, the defective nozzle is masked based on the mask files updated by the present program and if needed, a correction processing is performed to execute the practical print processing.

Next, a defect detecting chart 300 according to the present exemplary embodiment will be described with reference to FIGS. 6A to 6C.

As illustrated in FIG. 6A, the defect detecting chart 300 according to the present exemplary embodiment includes a defective nozzle detecting pattern 302 and a stripe determining pattern 304.

The defective nozzle detecting pattern 302 is a pattern for determining an approximate position of a defective nozzle and includes a so-called ladder pattern as illustrated in FIG. 6B or includes a marking pattern 302b as illustrated in FIG. 6C. Image information representing the defect detecting chart 300 is stored in the storage unit 110 or the like, and if needed, read out by the CPU 100 to be used. This is the same for the other test patterns to be described later.

Further, in the present exemplary embodiment, the defect detecting chart 300 is provided for each of the colors of magenta (M), yellow (Y), cyan (C), and black (K). However, one of them will be exemplified and described below.

The ladder pattern 302a in the present exemplary embodiment as illustrated in FIG. 6B is a pattern in which segments with a predetermined length are repeatedly printed using each of the nozzles 48a-1 to 48a-N of the ink-jet recording head 48 illustrated in FIG. 3 at intervals of three nozzles. That is, the nozzles 48a-1 to 48a-3 are driven according to position numbers 1 to 3 illustrated in the drawing to print a straight line extending in the conveyance direction of the recording paper P, then returned to the original position, and then the nozzles 48a-N to 48a-6 are driven at position numbers 1 to 3 to print the straight lines. Likewise for the remaining nozzles 48a, the straight lines are printed by the nozzles up to the nozzle 48a-N.

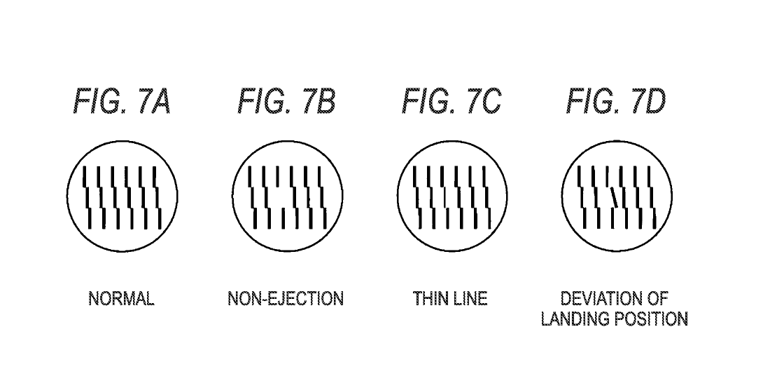

FIGS. 7A to 7D illustrate partial enlarged views of print results of the latter pattern 302a according to defective aspects of nozzles, respectively.

FIG. 7A illustrates a case in which the ejection of the nozzles 48a is normal. When a certain disorder occurs at a nozzle 48a so that normal print cannot be performed, each printed segment causes a deviation from the normal print pattern according to the disorder state of the nozzle.

FIG. 7B is an example of a case in which ink droplets cannot be ejected from a nozzle 48a due to a certain reason (defect of non-ejection) in which the print of a segment is omitted at the position corresponding to the nozzle 48a where the defect has occurred.

FIG. 7C is an example of a case in which the ejection amount of ink droplets from a nozzle 48a decreases due to a certain reason (defect of thin line) in which the segment printed at the position corresponding to the nozzle 48a in which the defect has occurred is thinned.

FIG. 7D is an example of a case in which curved flight of ink droplets ejected from a nozzle 48a is caused due to a certain reason (defect of deviation of landing position) in which the segment at the position corresponding to the nozzle where the defect has occurred is curved.

In the present exemplary embodiment, the user visually confirms and determines a search range which corresponds to the nozzle numbers of a predetermined range including a defective nozzle based on the result of the defective nozzle detecting pattern 302. As an example of grasping a nozzle number, in the present exemplary embodiment, nozzle numbers 306 are printed to accompany with the defective nozzle detecting pattern 302.

FIG. 6B illustrates an example of a case of a ladder pattern 302a in which the nozzle numbers 306 are indicated by numbers from 100 to 700.

In addition, in the example of FIG. 6B, the defect of non-ejection occurs at a position indicated by symbol “N” in the drawing in the vicinity of the nozzle number 500. As the user confirmed the print result of the defective nozzle detecting pattern 302, the search range is determined as, for example, “10 nozzles from the nozzle number 500.”

As in the above described ladder pattern 302a, the search range may be determined based on the marking pattern 302b of FIG. 6C.

Meanwhile, the stripe determining pattern 304 is a pattern for printing a beta image with a plurality of print densities in which the pattern is a pattern for practically causing a print disorder caused by a defective nozzle. In the example of FIG. 6A, the stripe determining pattern 304 includes a stripe determining pattern 304A of print density 100%, a stripe determining pattern 304B of print density 80%, a stripe determining pattern 304C of print density 60%, a stripe determining pattern 304D of print density 40%, and a stripe determining pattern 304E of print density 20%.

In addition, the print densities for beta printing are not limited to these and may be configured by combining arbitrary print densities.

The example of FIG. 6A illustrates an example in which a print disorder of a white stripe (the portion indicated by symbol “S” in the drawing) occurs in the stripe determining pattern 304B of print density 80%. By printing the stripe determining pattern 304 with a plurality of print densities in this manner, a print disorder caused by a defective nozzle depending on the print densities is detected.

Further, although the present exemplary embodiment is configured such that the user determines a print disorder caused by a defective nozzle by visually recognizing the print result of the stripe determining pattern 304, the printer disorder may be determined by, for example, the CPU 100 of the image forming apparatus 10 based on the image information read out by the optical sensor 80 from the stripe determining pattern 304 printed on the recording paper P.

When the user confirms the print result of the defect detecting chart 300 in this manner, the nozzle search range including the defective nozzle and the print density where the print disorder has occurred may be grasped. That is, in the example of FIGS. 6A to 6C, the search region is grasped as “10 nozzles from the nozzle number 500” and the print density where the print disorder occurs is grasped as 80%.

Next, a method of specifying a defective nozzle in the image forming apparatus 10 according to the present exemplary embodiment will be described with reference to FIG. 8.

In the present exemplary embodiment, for example, the nozzles 48a are sequentially non-operated from the nozzle 48a having the smallest nozzle number to the nozzle 48a having the largest nozzle number in the range of designated nozzle numbers in the search range grasped as described above (in the example of FIGS. 6A to 6C, “10 nozzles from the nozzle number 500”) and a defective nozzle specifying pattern 400 is printed to specify a defective nozzle. The defective nozzle specifying pattern 400 in the present exemplary embodiment is a beta pattern formed within a paper width in which the defective nozzle specifying pattern 400 is printed using the print density where the print disorder grasped in the above-described manner occurs (in the example of FIGS. 6A to 6C, 80%). In addition, in the present exemplary embodiment, when sequentially non-operating the nozzles 48a, correction is performed for a defective nozzle included in the nozzles 48a other than the non-operated nozzle 48a.

Part (a) of FIG. 8 illustrates an example of a print result of the defective nozzle specifying pattern 400 printed by the image forming apparatus 10 after the user inputs the search range and the print density grasped as described above through the UI panel 108 or the like.

In the example of Part (a) of FIG. 8, five defective nozzle specifying patterns 400-1 to 400-5 in the sequence of numbers of 1 to 5 are printed and the defective nozzle specifying patterns 400-1 to 400-5 are made to correspond to the nozzle numbers of the non-operated nozzles, respectively. In Part (a) of FIG. 8, the numbers within parentheses indicate the nozzle numbers and the print results by the nozzles of nozzle numbers 500 to 504 among nozzle numbers 500 to 509 are illustrated.

In Part (a) of FIG. 8, in the print result of print sequence 1, a white stripe S occurs, in the print result of print sequence 2, the white stripe disappears, and in continued print sequences 3 to 5, a white sequence S occurs again. By the user who has visually recognized the results, it is determined that the nozzle 48a of nozzle number 501 corresponding to the defective nozzle specifying pattern 400-2 is the cause of the print disorder. This is because the white stripe S which has been visually recognized at that time becomes invisible since the correction processing has been executed by non-operting the nozzle 48a of nozzle number 501.

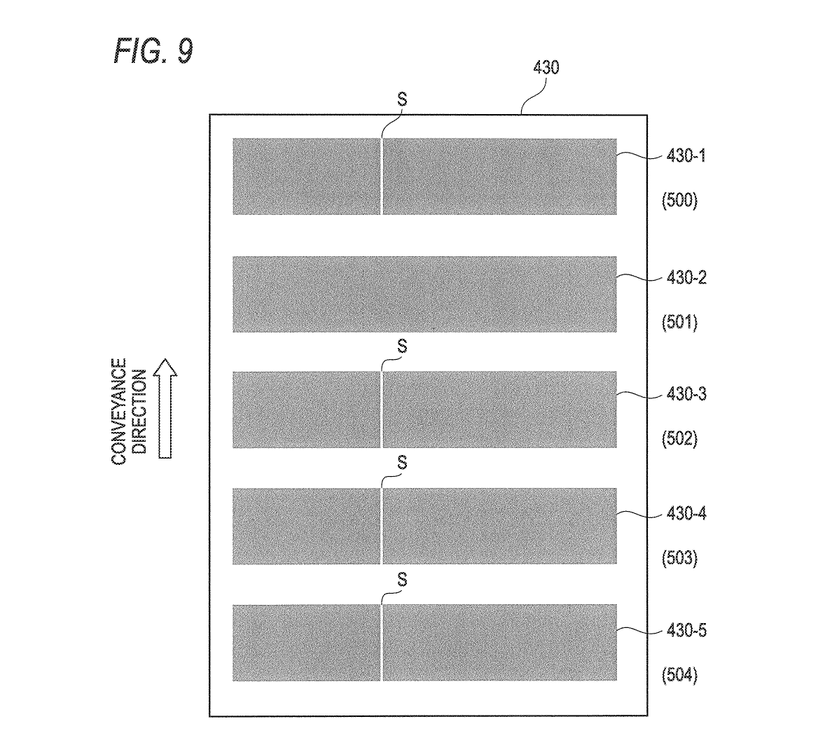

Further, in the present exemplary embodiment, although a type of a defective nozzle specifying pattern 400 printed on one recording paper P per each non-operated defective nozzle has been exemplified and described, the printing defective nozzle specifying patterns may be printed on one recording paper P like the defective nozzle specifying pattern 430 illustrated in FIG. 9.

In FIG. 9, the defective nozzle specifying patterns 430-1 to 430-5 which are made to correspond to the nozzle numbers 500 to 504 (indicated by numbers within parentheses in FIG. 9) in the search range are printed in one defective nozzle specifying pattern 430.

Since the method of specifying a defective nozzle using the defective nozzle specifying pattern 430 is the same as that using the defective nozzle specifying pattern 400, the descriptions thereof will be omitted.

Next, correction according to the present exemplary embodiment will be described.

As described above, in the image forming apparatus 10 according to the present exemplary embodiment, the defect detecting chart 300 or the defective nozzle specifying pattern 400 is printed while performing correction on the defective nozzles determined up to now based on the mask files in steps S700 and S704 of the flowchart of FIG. 4.

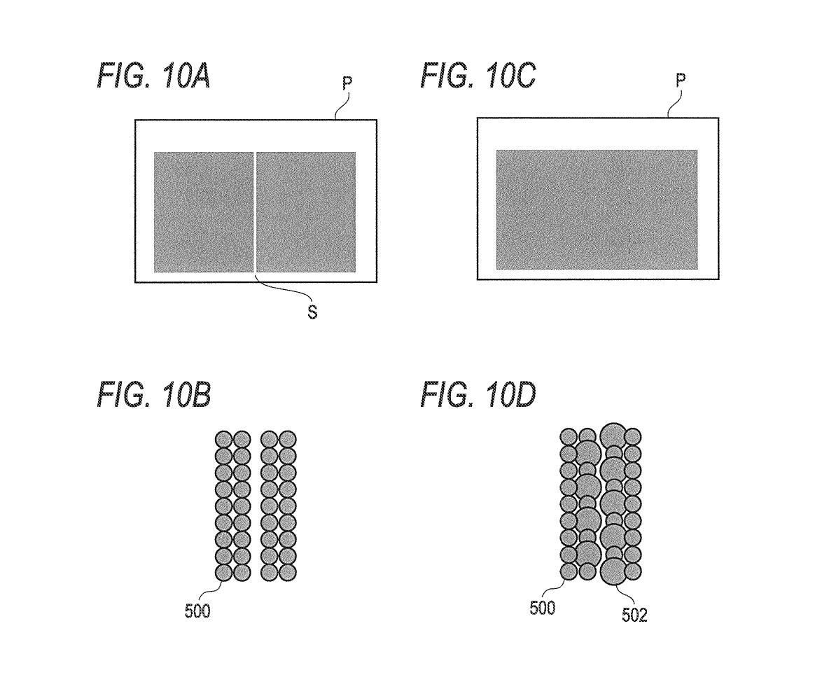

FIGS. 10A to 10D are explanatory views for describing the correction. In addition, the correction according to the present exemplary embodiment is executed as the CPU 100 controls the correction unit 122.

FIG. 10A illustrates a beta image printed on a recording paper P in a state where defective nozzles were masked and FIG. 10B illustrates a state where the ink droplets 500 ejected from two rows of nozzles at each side of defective nozzles landed on the recording paper P when the beta image was printed. As illustrated in these drawings, only with masking the defective nozzles, a white stripe S frequently occurs.

FIG. 10C illustrates a beta image printed on the recording paper P in a state where the image was corrected using the nozzles at each side of defective nozzles and FIG. 10D illustrates a state where the ink droplets ejected from two rows of nozzles at each side of defective nozzles landed on the recording paper P when the beta image was printed. As illustrated in FIGS. 10C and 10D, in the present exemplary embodiment, the ink droplets from the nozzles that execute correction are formed as large droplets 502 which are larger ink droplets as compared to those formed at the time of performing usual printing.

As illustrated in FIG. 10C, the white stripe illustrated in FIG. 10A becomes hardly visible by performing the correction.

Here, in the present exemplary embodiment, the correction processing is performed in such a manner that large droplets 502 are ejected from the nozzles other than defective nozzles but not necessarily limited thereto. The correction may be performed using a usual ejection amount of ink droplets 500. In such a case, it is preferable to perform the correction while increasing, for example, the number of ejected ink droplets.

In addition, as the nozzles that perform the correction, it is not needed to necessarily use the nozzles at the opposite sides of and adjacent to the defective nozzles. The nozzles of any one side of the defective nozzles may be used and the nozzles may not be necessarily adjacent to the defective nozzles.

As described above, according to the image forming apparatus 10 according to the present exemplary embodiment, it is possible to efficiently specify a defective nozzle occurring with various print densities while suppressing a possibility of failing to specify the defective nozzle. In addition, prior to practical printing, the ejection of ink droplets of a defective nozzle specified by a defective nozzle specifying program is stopped and as needed, correction may be performed.

In addition, in the above-described exemplary embodiment, although a type of preparing a defective nozzle specifying pattern 400 or 430 for specifying a defective nozzle separately has been exemplified and described, the present invention is not limited to this and may specify the defective nozzle with the defect detecting chart 300 without using the defective nozzle specifying pattern 400 or 430. In this case, the defective nozzle is specified using the stripe determining pattern 304 of the defect detecting chart 300 with a method that is the same as the method described with reference to Part (a) of FIG. 8.

Further, in the above-described exemplary embodiment, although a search range for specifying a defective nozzle is obtained by the defective nozzle detecting pattern 302 of the defect detecting chart 300 and the defective nozzle specifying pattern 400 is printed based on the search range, the present invention is not limited thereto. For example, according to the number of nozzles 48a, the nozzles may be non-operated, for example, from the nozzle at a terminal end to print a defective nozzle specifying pattern 400.

In addition, in the above-described exemplary embodiment, although a print density where a print defect occurs is specified by the stripe determining pattern 304 of the defect detecting chart 300 and the defective nozzle specifying pattern 400 is printed with the print density, the present invention is not limited thereto and may perform printing with, for example, a print density predetermined by the user.

In addition, in the above-described exemplary embodiment, the nozzles are sequentially non-operated one by one when a defective nozzle is specified based on the defective nozzle specifying pattern 400. However, the present invention is not limited thereto and may specify a defective nozzle while non-operating a plurality of nozzles at a time in the search range to narrow the range.

In addition, in the above-described exemplary embodiment, an aspect in which a defect detecting chart 300 or a defective nozzle specifying pattern 400, 430 is while correction is being performed based on a mask file in which defective nozzles specified in the past are stored have been exemplified and described. However, the present invention is not limited to this and may perform printing without performing the correction. For example, when a defective nozzle which produces a black stripe (which may be produced by a defect of deviation of land position or the like) is specified, it is not needed to necessarily perform the correction since the black stripe is differentiated from a white stripe.

In addition, in the exemplary embodiment, an aspect in which specified defective nozzles are stored in a mask file in sequence has been exemplified and described. However, the present invention is not limited thereto and may employ an aspect in which, whenever a defective nozzle occurs, the defective nozzle is masked without using a mask file.

### Second Exemplary Embodiment

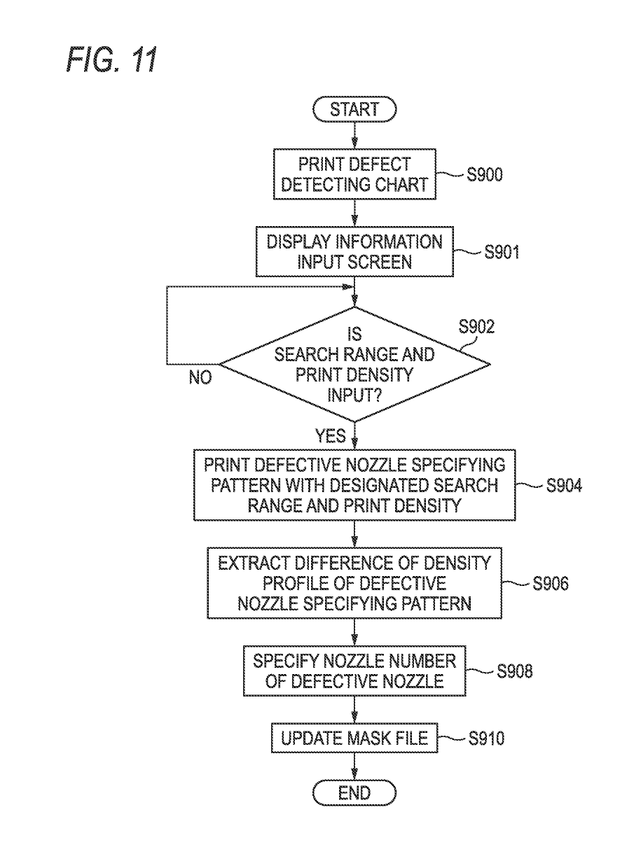

With reference to FIG. 8 and FIG. 11, an image forming apparatus 10 according to the present exemplary embodiment will be described.

In the first exemplary embodiment, the user visually confirms a printed defective nozzle specifying pattern 400 to specify a defective nozzle. However, in the present exemplary embodiment, a defective nozzle is specified by the image forming apparatus 10.

Specifically, each of a plurality of defective nozzle specifying patterns 400 are read out by an optical sensor 80 to calculate density profiles (density integration values), and a difference between the density profiles is taken to specify a defective nozzle. In the present exemplary embodiment, since the defective nozzle specifying patterns 400 are compared by the difference of the density profiles, the optical sensor 80 is not needed to necessarily have a high resolution and an optical sensor 80 of a low resolution may be used.

With reference to FIG. 11, the action of the image forming apparatus 10 according to the present exemplary embodiment will be described.

FIG. 11 is a flowchart illustrating a processing flow of a defective nozzle specifying program executed by the CPU 100. The program is stored in a predetermined region in the ROM 102.

In addition, as in the case of the flowchart of FIG. 4, it is assumed that an instruction of execution of a defective nozzle specifying processing has been already made by the user through the UI panel 108 or the like and also, for a defective nozzle masked in the past, information that specifies the defective nozzle is stored in the storage unit 110 or the like as mask data (not illustrated).

Since steps S900 to S904 are the same as steps S700 to S704 of FIG. 4, the descriptions thereof will be omitted.

In step S906, based on density profiles which are the result of read-out of the plurality of printed defective nozzle specifying patterns by the optical sensor 80, a difference of density profiles between defective nozzle specifying patterns is extracted. The extracted difference may be temporally stored in the RAM 104 or the like.

In the next step S908, the nozzle number of the defective nozzle is specified based on the difference extracted in step S906.

In the next step S910, the nozzle number of the defective nozzle specified in step S908 is added to a mask file and stored to update the mask file and then the defective nozzle specifying program is ended.

Part (b) of FIG. 8 illustrates density profiles which are density integration values in the vertical scanning direction of image densities in a case where the defective nozzle specifying patterns 400 are read out by the optical sensor 80 illustrated in Part (a) of FIG. 8 and Part (c) of FIG. 8 illustrates the differences between the density profiles. In Part (b) of FIG. 8, the horizontal axis represents a position P in the scanning direction, and the vertical axis represents a density profile DS. In addition, in Part (c) of FIG. 8, the horizontal axis represents a position P in the scanning direction and the vertical axis represents a DS which is a difference of density profiles DS. In Part (c) of FIG. 8, the indication of difference 2-1 represents that it is a difference obtained by subtracting the density profile of the defective nozzle specifying pattern 400-1 from the density profile of the defective nozzle specifying pattern 400-2 and the other indications are the same.

Referring to Part (c) of FIG. 8, since a plus peak occurs at difference 2-1, a nozzle corresponding to the defective nozzle specifying pattern 400-2, i.e., the nozzle corresponding to the nozzle number 501 is specified as a defective nozzle.

As described above, with the image forming apparatus 10 according to the present exemplary embodiment, a defective nozzle occurring with various print densities may also be efficiently specified while suppressing a possibility of failing to specify the defective nozzle.

Also, prior to practical printing, ejection of ink droplets of defective nozzle by a defective nozzle specifying program is stopped and correction is performed as needed, which is the same as in the first exemplary embodiment.

Further, in the above-described exemplary embodiment, an aspect in which integration values of image densities of defective nozzle specifying patterns are used as density profiles have been exemplified and described, the present invention is not limited thereto. For example, it may also be possible to calculate a difference of density profiles along one line of which the scanning direction of a defective nozzle specifying pattern is predetermined and to specify a defective nozzle based on the difference.

### Third Exemplary Embodiment

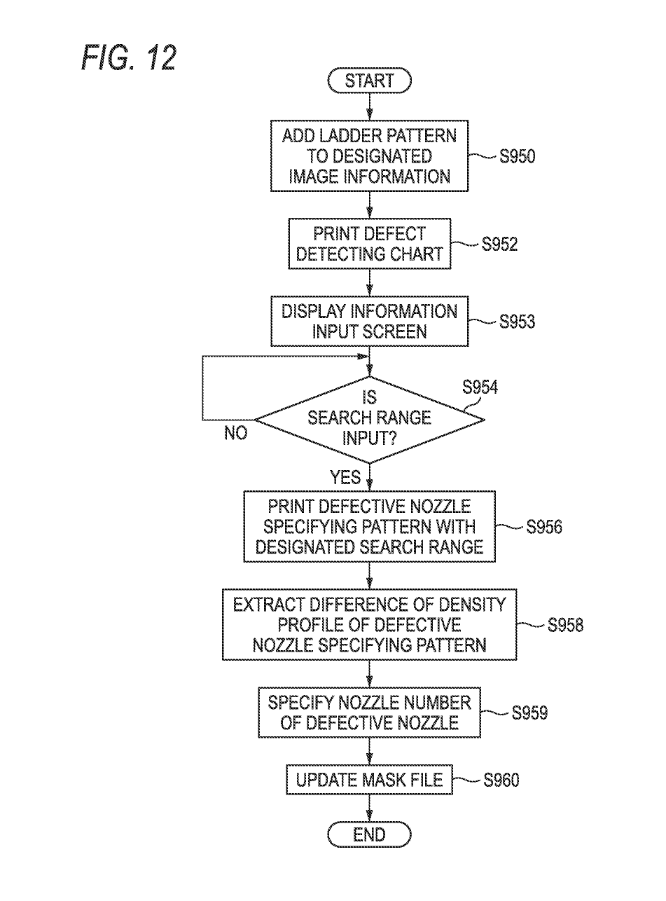

With reference to FIGS. 12 to 14, the image forming apparatus 10 according to the present exemplary embodiment will be described. The present exemplary embodiment uses an image designated by the user (e.g., a practically printed manuscript or the like) (hereinafter, referred to as a “designated image”) instead of the defect detecting chart 300 and defective nozzle specifying patterns 400 in the first exemplary embodiment. The image information of the designated image may be stored in the storage unit 110 in advance or read out by the scanner unit and stored in the storage unit 110 prior to practical printing.

With reference to FIG. 12, the action of the image forming apparatus 10 according to the present exemplary embodiment will be described.

FIG. 12 is a flowchart illustrating a processing flow of a defective nozzle specifying program executed by the CPU 100 in which the program is stored in a predetermined region in the ROM 102.

As in the flowchart of FIG. 4, it is assumed that an instruction of executing a defective nozzle specifying processing has already been made by the user through the UI panel 108 or the like and for a defective nozzle masked in the past, the information specifying the defective nozzle has been stored in the storage unit 110 or the like as master data (not illustrated). In addition, it is also assumed that designated image information stored in the storage unit 110 or the like has already been designated by the user.

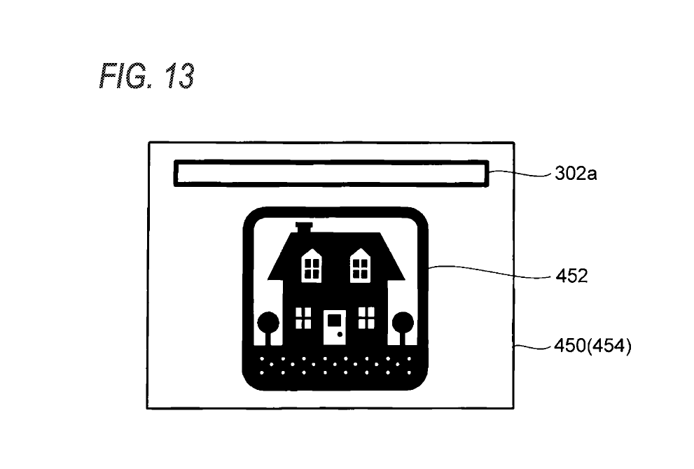

At first, in step S950, the designated image information is read out from the storage unit 110 and image information of a defect detecting chart is prepared by adding image information of a ladder pattern to the designated image information (see FIG. 13).

In the next step S952, the defect detecting chart is printed. In the present exemplary embodiment, the corresponding defect detecting chart is a designated image in which the ladder pattern is added in step S950.

In the next step S953, an information input screen for inputting a search range is displayed on the UI panel 108. The display screen of the UI panel 108 at this time may be the same as FIG. 5A.

Since the user confirms the printed defect detecting chart and inputs the search range on the UI panel 108 or the like, in the next step S954, input stand-by of the search range is performed to stand by until the search range is input by the user.

When the search range is input by the user, in the next step S956, defective nozzle specifying patterns are printed while sequentially non-operating the nozzles in the search range. In the present exemplary embodiment, the defective nozzle specifying pattern is a designated image in which the ladder pattern is added in step S950.

In the next step S958, the sequentially printed defective nozzle specifying patterns are read out by the optical sensor 80 to calculate density profiles, and then a difference of the density profiles between the defective nozzle specifying patterns is extracted.

In the next step S959, the nozzle number of a defective nozzle is specified based on the difference of the density profiles extracted in step S958.

In the next step S960, the nozzle number of the defective nozzle specified in step S959 is added to and stored in the mask file to update the mask file and the defective nozzle specifying program is ended.

FIG. 13 illustrates an example of the defect detecting chart 450 according to the present exemplary embodiment. As illustrated in the drawing, the defect detecting chart 450 is configured to include a designated image 452 designated by the user and the latter pattern 302a illustrated in FIG. 6B. Although the place where the ladder pattern 302a may be any blank space on the recording paper, in the present exemplary embodiment, it is added in the leading blank space. In addition, the defective nozzle detecting pattern 302 may not be the ladder pattern 302a but the marking pattern 302b illustrated in FIG. 6C.

The function and using method of the defect detecting chart 450 according to the present exemplary embodiment is the same as those of the defect detecting chart 300 as illustrated in FIG. 6A and the search range is specified by the ladder pattern 302a.

Also, in the present exemplary embodiment, the defect detecting chart 450 also serves as the defective nozzle specifying pattern 454 in step S956 of FIG. 12. The step of specifying the print density using the defect detecting chart 450 as in the first exemplary embodiment (see, step S702 of FIG. 4) is not performed.

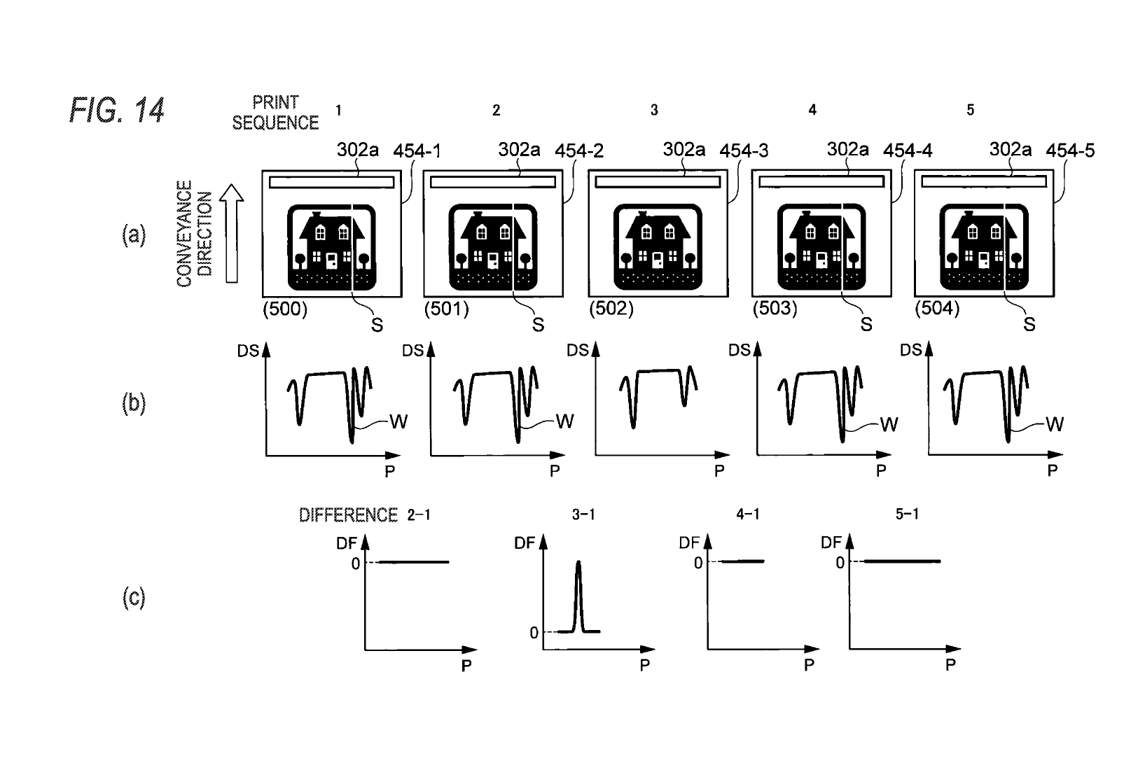

Next, a method of specifying a defective nozzle in the present exemplary embodiment will be described with reference to FIG. 14.

Part (a) of FIG. 14 illustrates a print result of the defective nozzle specifying pattern 454 printed in step S956 of FIG. 12. The search range (i.e., the range of sequentially non-operated nozzles) according to the present exemplary embodiment is also set to nozzle numbers 500 to 509 as in the first exemplary embodiment in which Part (a) of FIG. 14 illustrates the print result of the defective nozzle specifying patterns 454-1 to 454-5 which correspond to nozzle numbers 500 to 504 (the numbers indicated in parentheses in Part (a) of FIG. 14).

Part (b) of FIG. 14 illustrates density profiles when the defective nozzle specifying patterns 454 illustrated in Part (a) of FIG. 14 are read out by the optical sensor 80 and Part (c) of FIG. 14 illustrates differences between the density profiles. In Part (b) of FIG. 14, the horizontal axis represents a position P in the scanning direction and the vertical axis represents a density profile DS. In addition, in Part (c) of FIG. 14, the horizontal axis represents a position P in the scanning direction and the vertical axis represents a difference DF of density profiles DS. In Part (c) of FIG. 14, the indication of difference 2-1 indicates that it is a difference obtained by subtracting the density profile of the defective nozzle specifying pattern 454-1 from the density profile of the defective nozzle specifying pattern 454-2 and the other indications are the same.

As illustrated in Part (b) of FIG. 14, in the defective nozzle specifying patterns 454-1, 454-2, 454-4, 454-5 in which a white stripe occurs, a peak W is adapted to occur at a density profile DS corresponding to the white stripe S. Meanwhile, the peak W disappears in the defective nozzle specifying pattern 454-3 where no while stripe occurs.

Referring to Part (c) of FIG. 14, since a plus peak occurs at difference 3-2, it may be seen that the nozzle corresponding to the defective nozzle specifying pattern 454-3, i.e. the nozzle corresponding to nozzle number 502 is a defective nozzle. In the present exemplary embodiment, the defective nozzle is specified in this manner.

As described above, according to the image forming apparatus 10 according to the present exemplary embodiment, a defective nozzle occurring with various print densities may be efficiently specified while suppressing a possibility of failing to specify the defective nozzle more securely.

In addition, in the present exemplary embodiment, although an aspect in which the print result of defective nozzle specifying patterns 454 are read out by the optical sensor to specify a defective nozzle has been exemplified and described, the defective nozzle may be specified by the user's selection of the best print result as in the first exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of nozzles that eject liquid droplets;
an image forming unit that determines at least some of the plurality of nozzles as nozzles that do not eject liquid droplets, and to form a plurality of images by performing image formation for each of the determined nozzles based on image information predetermined using the remaining nozzles other than the determined nozzles; and
an acquisition unit that acquires information representing a defective nozzle which is unusual in ejection of liquid droplets among the plurality of nozzles based on the plurality of images formed by the image forming unit.

2. The image forming apparatus of claim 1, wherein the image forming unit determines some nozzles specified based on a first image, which enables a position of each of the plurality of nozzles to be specified, as nozzles that do not eject liquid droplets, and determines an image forming density of the predetermined image information in such a manner that an image is formed in an image density specified based on a plurality of images which are formed by the liquid droplets ejected from the plurality of nozzles and have different image forming densities.

3. The image forming apparatus of claim 1, wherein the acquisition unit acquires the information representing the defective nozzle which a user specifies based on the plurality of images formed by the image forming unit.

4. The image forming apparatus of claim 1, further comprising:
a read-out unit that reads out an image formed on a recording medium,
wherein the acquisition unit calculates integration values of image densities according to a direction of conveying the recording medium for each of the plurality of images from image information obtained by reading out, by the read-out unit, the plurality of images formed by the image forming unit, and acquires the information representing the defective nozzle based on differences of the integration values of image densities.

5. The image forming apparatus of claim 1, wherein the image forming unit conducts a control such that no liquid droplet is ejected from the defective nozzle and liquid droplets are ejected from the nozzles other than the defective nozzle among the plurality of nozzles based on image information for forming an image by causing image formation in a direction interesting a direction of conveying the recording medium to be performed in an integrated manner at once.

6. The image forming apparatus of claim 5, wherein the image forming unit conducts a control such that the image information for forming an image is corrected and a region corresponding to the defective nozzle in the recording medium is formed with an image by liquid droplets ejected from the nozzles other than the defective nozzle among the plurality of nozzles.

7. An image forming method comprising:
determining at least some of a plurality of nozzles ejecting liquid droplets as nozzles that do not eject liquid droplets;
forming a plurality of images by performing image formation for each of the determined nozzles based on image information predetermined using the remaining nozzles other than the determined nozzles; and
acquiring information representing a defective nozzle which is unusual in ejection of liquid droplets among the plurality of nozzles based on the plurality of images formed by the image forming unit.

8. A non-transitory computer readable medium storing a program causing a computer to execute a process for a communication, the process comprising:
determining at least some of a plurality of nozzles ejecting liquid droplets as nozzles that do not eject liquid droplets;
forming a plurality of images by performing image formation for each of the determined nozzles based on image information predetermined using the remaining nozzles other than the determined nozzles; and
acquiring information representing a defective nozzle which is unusual in ejection of liquid droplets among the plurality of nozzles based on the plurality of images formed by the image forming unit.
